(19) United States
(12) Patent Application Publication
(10) Pub. No.: US 2024/0346411 A1
(43) Pub. Date: Oct. 17, 2024

(54) PROJECT SCHEDULING SYSTEMS AND METHODS

(71) Applicant: DISH WIRELESS L. L. C., Englewood, CO (US)

(72) Inventor: MOHAMMAD GUDARZI, Syracuse, NY (US)

(21) Appl. No.: 18/133,919

(22) Filed: Apr. 12, 2023

(51) Int. Cl. G06Q 10/0631

(52) U.S. Cl. CPC G06Q 10/063118

(57) ABSTRACT

Project scheduling systems and methods provide a set of automated functionality to schedule project activities related to site deployments, for example, a wireless cellular telecommunication cell site deployment. The system performs a series of calculations and value lookups to forecast or re-forecast a cell site's installation and deployment project timeline. To calculate the timeline for a single site, the project scheduling system is able to: define the activities, sequence the activities, estimate the activity durations (lead times); and calculate the timeline based on the estimated durations and task dependencies.

### BRIEF SUMMARY

In the technology of computerized project scheduling, forecasting project activities accounting for changing lead times, start dates and activity dependencies and integrating all this seamlessly with external technological systems, remains a complex process with many technical problems that need to be solved. For example, in a telecommunication site deployment project, each site build is a mini construction project that has to be baselined, scheduled, and monitored until completion. Technological systems of project managers, market managers and other teams need the ability to forecast completion dates of multiple milestones to have an accurate picture of the project schedule and completion forecasts. In a typical Fifth Generation (5G) wireless telecommunication site deployment, the lead times for forecast cascading vary based on several parameters e.g., city, structure type, area of interest, general contractor, fiber, power, weather, and the like. There may be one or more issues based on these parameters, potential issues or errors made during the deployment of a wireless site that may cause delay in network deployment, operation and maintenance. For example, conventional telecommunication project management software systems do not provide the capability for mass data manipulation and editing. The earlier such issues, potential issues and errors may be identified and addressed, the more time and costs can be saved by the computerized project scheduling technology when managing and deploying the network sites in a telecommunication project. It is with respect to these and other considerations that the embodiments described herein have been made.

Briefly described, embodiments disclosed herein are directed to a project scheduling system and method. For example, a method for scheduling projects may include electronically receiving project data for a plurality of projects from an associated project management system; electronically assigning, by the control module, a preliminary lead time to each project of the plurality projects and storing the same; electronically generating, by the control module, a look-up table for the plurality of projects; electronically identifying, by the control module, one or more dependencies between one or more projects of the plurality of projects based on one or more dependency rules; electronically modifying, by the control module, a preliminary lead time for one or more projects in the look-up table in response to user input; electronically modifying, by the control module, a preliminary start date for one or more projects in the look-up table in response to user input; electronically updating, by the control module, a corresponding schedule of the one or more projects based on the modified preliminary lead time, the modified preliminary start date and the identified one or more dependencies; electronically displaying data indicative of the updated corresponding schedule in response to the updating of the corresponding schedule; and electronically transmitting to the associated project management system data indicative of the updated corresponding schedule.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings.

FIG. 1 illustrates a block diagram of a projection scheduling system, in accordance with an embodiment of the present disclosure.

FIG. 2 illustrates an exemplary method flow diagram for scheduling projects in accordance with an implementation of the system as described in FIG. 1, in accordance with an embodiment of the present disclosure.

FIG. 3 illustrates a method flow diagram of monitoring activities in a scheduled project, in accordance with an embodiment of the present disclosure.

FIG. 4 illustrates an exemplary first data export view user interface of the scheduling system, in accordance with an embodiment of the present disclosure.

FIG. 5 illustrates a representation of an interactive user interface including an interactive and modifiable lead time table of the scheduling system, in accordance with an embodiment of the present disclosure.

FIG. 6 illustrates a number of diagnostic rules in an interactive and modifiable diagnostic rules table, in accordance with an embodiment of the present disclosure.

FIG. 7 represents an exemplary illustration of an aspect of the scheduling system showing a second data export view user interface, in accordance with an embodiment of the present disclosure.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

The project scheduling system disclosed herein is highly useful when it comes to saving time and effort when provided to work in tandem with project management systems. The system manages multiple steps in a schedule for a project for every single site. The system performs a series of calculations and value lookups to forecast or re-forecast a site's installation and deployment project timeline. To calculate the timeline for a single site, the scheduler system described herein is able to: define the activities, sequence the activities, estimate the activity durations (lead times); and calculate the timeline based on the estimated durations and task dependency.

Furthermore, a change in any milestone can create a cascade effect, meaning all the dependent milestones are also re-forecasted in response when scheduling groups of sites. The system may identify dependency issues and ensures, or enables the project manager to ensure, that there are no dependency issues and that the forecast dates are based on the defined sequence.

Considering that on average a market has between 500-1000 sites that require baselining, scheduling, and controlling during the deployment, it is impossible to effectively manage the deployment schedule in one's mind without a tool such as that described herein that helps speed up the scheduling and concurrently performs a series of calculations and value lookups to forecast or re-forecast a site's timeline. Moreover, scheduling activities are iterative and have to be repeated several times during a forecasting session or a baselining practice. Using the manual process, it could take 2-3 days to schedule and validate market data. Consequently, users have to minimize their data updates to the associated project management system in order to save time.

Furthermore, existing project management systems do not provide tools for mass data manipulation and editing. Also, concurrently and/or simultaneously finding dependency issues manually in one's mind is impossible considering the amount of data that has to be analyzed (simultaneously checking in excess of 40 rules for every site of thousands of sites every day).

Towards this end, the present disclosure provides an automated project scheduling system (also referred to as a “scheduling tool” herein). It more efficiently automates a process of data cleanup, data validation, data analysis, timeline calculations, and updates in an associated project management system and, as opposed to traditional computerized project scheduling systems, can perform such operations simultaneously and/or concurrently, thereby improving the technology of computerized project scheduling. The scheduling tool has different functionalities that forecast, validate, and update site data faster and on a bigger scale than traditional computerized project scheduling systems. The system also gives the user flexibility to customize import parameters for the calculations. The scheduling tool helps calculate and recalculate project schedules and prepare data for uploaded to an associated project management system in minutes. The project scheduling system includes a cascade feature that allows for the propagation of changes in a project's timeline through dependent tasks, ensuring that the overall schedule remains accurate and up-to-date. The scheduling tool gives the user flexibility to forecast and manage the schedule for a single site or groups of sites based on different lead time or activity dependency settings. Further, the automated project scheduling system gives users the possibility to edit their project data.

Further, the scheduling tool of the present disclosure involves a suitable estimation technique that helps in estimating the time required to complete each project activity and determining, for example, a critical path and/or a longest sequence of sub-activities required to complete a given project. The estimation technique provides a comprehensive way to plan, schedule, and control complex projects.

By following these features, project managers can effectively estimate the time required to complete each project activity, identify critical path activities, and develop a realistic project schedule that can be closely monitored and adjusted as needed. The project scheduling tool of the present disclosure is therefore a collection of different automation and lookup tools that, among other operations: cascades milestone forecast dates for groups of sites; flexibly changes estimations during forecasting; finds dependency issues, validates data, and fine-tunes the schedule; tracks specific tasks through custom views (example: material shipment requests, Lock view, notice to proceed finder, building permit finder); monitors the execution by quickly checking any upcoming activities (look ahead); and bulk uploads forecast dates and general information to a source database or project management system.

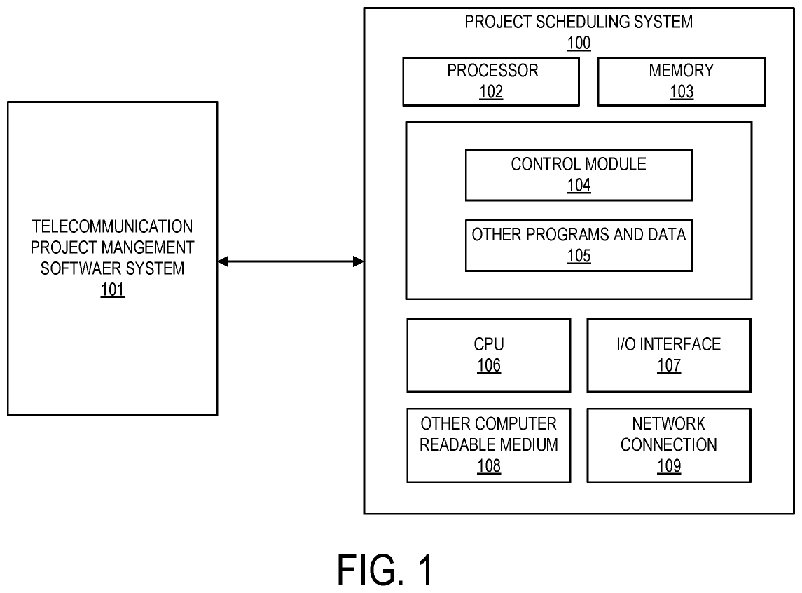

FIG. 1 illustrates an exemplary projection scheduling system that describes an example implementation of computing system(s) for implementing embodiments described herein.

The functionality described herein for the project scheduling system 100 can be implemented either on dedicated hardware, as a software instance running on dedicated hardware, or as a virtualized function instantiated on an appropriate platform. FIG. 1 illustrates an example of underlying hardware on which such software and functionality may be hosted and/or implemented. For example, the project scheduling systems 100 may represent and/or include example components of underlying computer hardware for some or all of the components shown in FIGS. 1-7.

In particular, shown is example project scheduling system 100, which may also comprise scheduling systems or sub-systems. For example, project scheduling system 100 may represent one or more of those in various operation centers, data centers, base stations and cell sites referred to herein that are, or that host or implement, the functions described herein for the purpose of scheduling project activities. In an embodiment, the project scheduling system 100 is communicatively coupled to an external telecommunication project management software system (TPMSS) 101. The project scheduling system 100 is configured to receive data from and upload updated data into the TPMSS 101 in one or more formats. In an embodiment, the project scheduling system 100 may give users an option to edit their project data, for example, in Microsoft (MS) Excel, and use all Excel-related functionality to create an upload file required to update forecast dates in the TPMSS 101. In an embodiment, the data may be uploaded by quick mass upload or general details mass upload, as per various user selections and requirements.

In some embodiments, one or more special-purpose computing systems may be used to implement the functionality described herein. Accordingly, various embodiments described herein may be implemented in software, hardware, firmware, or in some combination thereof. The project scheduling system 100 may include processor 102 and memory 103, one or more central processing units (CPUs) 106, I/O interfaces 107, other computer-readable media 108, and network connections 109.

Memory 103 may include one or more various types of non-volatile and/or volatile storage technologies. Examples of memory 103 may include, but are not limited to, flash memory, hard disk drives, optical drives, solid-state drives, various types of random-access memory (RAM), various types of read-only memory (ROM), neural networks, other computer-readable storage media (also referred to as processor-readable storage media), or the like, or any combination thereof. Memory 103 may be utilized to store information, including computer-readable instructions that are utilized by CPU 106 to perform actions, including those of embodiments described herein.

Memory 103 may have stored thereon control module(s) 104. The control module(s) 104 may be configured to implement and/or perform some or all of the functions of the systems, components and modules described herein for the automated project scheduling system. Memory 103 may also store other programs and data 105, which may include rules, programs, or models to perform the functionality described herein, user interfaces, operating systems, other network management functions, etc.

Network connections 109 are configured to communicate with other computing devices to facilitate the functionality described herein, such as with TPMSS 101. In various embodiments, the network connections 109 may include transmitters and receivers (not illustrated), cellular telecommunication network equipment and interfaces, and/or other computer network equipment and interfaces to send and receive data as described herein, such as to send and receive instructions, commands, and data to implement the processes described herein, I/O interfaces 107, other data input or output interfaces, or the like. Other computer-readable media 108 may include other types of stationary or removable computer-readable media, such as removable flash drives, external hard drives, or the like.

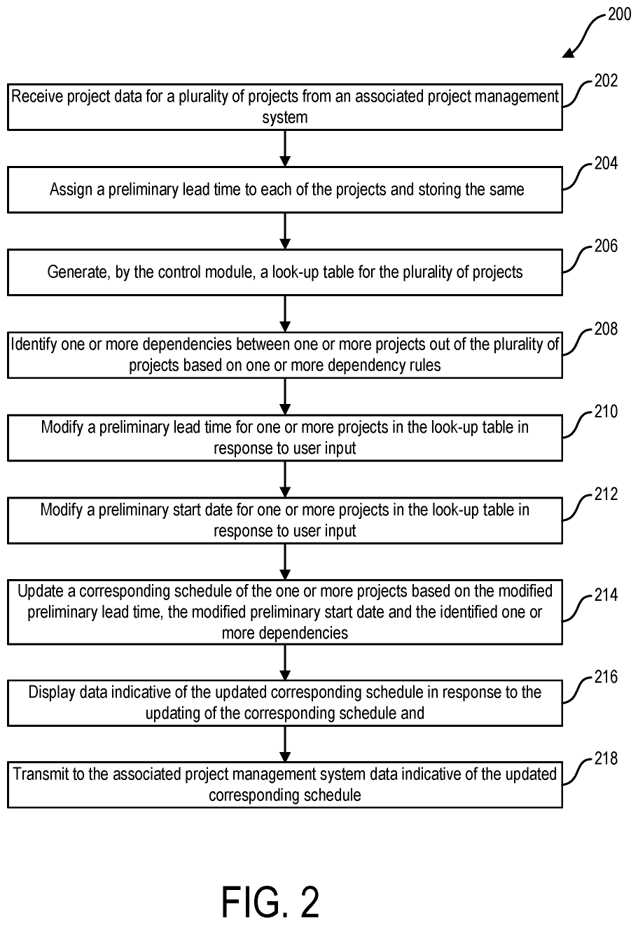

FIG. 2 illustrates an exemplary method flow diagram of a method 200 for scheduling projects in accordance with an implementation of the system as described in FIG. 1. In an example embodiment, the method 200 is adapted to schedule project activities and milestones on a site-to-site or group of sites basis. Also, the plurality of projects may comprise sub-activities of one of a plurality of larger projects.

At 202, the project scheduling system 100 electronically receives project data for a plurality of projects from an associated project management system. For example, the project data may be received via the I/O interfaces 107 and may be arranged in an Excel sheet by the project scheduling system 100. In an embodiment, the received project data may include various information, including, but not limited to, one or more of: project site information, structure type, transport provider, build plan year of the project, launch category of the project, vendor information, general contractor information, and longitude and latitude coordinates.

At 204, the project scheduling system 100 electronically assigns a preliminary lead time to each project of the plurality projects and stores the same.

At 206, the project scheduling system 100 electronically generates a look-up table for the plurality of projects.

At 208, the project scheduling system 100 electronically identifies one or more dependencies between one or more projects of the plurality of projects based on one or more dependency rules.

At 210, the project scheduling system 100 electronically modifies a preliminary lead time for one or more projects in the look-up table in response to user input.

At 212, the project scheduling system 100 electronically modifies a preliminary start date for one or more projects in the look-up table in response to user input.

At 214, the project scheduling system 100 electronically updates a corresponding schedule of the one or more projects based on the modified preliminary lead time, the modified preliminary start date and the identified one or more dependencies. In an example embodiment, this may include electronically updating a corresponding schedule of a plurality of projects simultaneously based on the modified preliminary lead time, the modified preliminary start date and the identified one or more dependencies.

At 216, the project scheduling system 100 electronically displays data indicative of the updated corresponding schedule in response to the updating of the corresponding schedule.

At 218, the project scheduling system 100 electronically transmits to the associated project management system data indicative of the updated corresponding schedule.

In an example embodiment, the project scheduling system 100 may analyze the received project data for a plurality of projects and provide recommendations for optimizing the updated corresponding schedule

In an example embodiment, the plurality of projects comprise sub-activities of one larger project of a plurality of larger projects. For example, the larger project may be installation and deployment of a particular cell site and the sub-activities are activities to be completed for the installation and deployment of a particular cell site. The project scheduling system 100 may apply a custom filter to the plurality of larger projects to list projects of the plurality of larger projects that meet certain selection criteria, based on the updated corresponding schedule, for completion of sub-activities within each larger project of the plurality of larger projects.

In an example embodiment, the project scheduling system 100, through the control module, may assign a weight to various project data based on one or more predefined factors and assign a preliminary lead time based on one or more rules to each of the projects, and store the same as weighted project data. In an embodiment, the control module 104 assigns the weights for the purpose of prioritizing projects/tasks. The weight assigned to each project data may indicate, for example, its impact on the overall success of the project. For example, if a particular project data is critical to the completion of the project, then a higher weight, for example, on a scale of 1-5, is assigned to that particular project data.

The control module 104 electronically generates a look-up table for the plurality of projects in accordance with weights assigned to the projects, wherein the look-up table is synchronized with the weighted project data. In an example implementation, the look-up table provides information on start and end dates, duration, and dependencies of various tasks in the projects.

In an example embodiment, the control module 104 may identify one or more dependencies in one or more projects out of the plurality of projects. In an embodiment, a user may also review lead times of the one or more projects based on one or more dependency conflicts as identified by the project scheduling system 100. Thus, the project managers are facilitated to review details, thus enabling them to assess dependency issues in an associated project management system data quickly. In an embodiment, the project scheduling system 100 may process and validate the project schedule (at milestone level) using a plurality of diagnostic rules. Here, the rules define a type of discrepancy which may occur, for example, in a case of a telecommunication site deployment project, fiber installation should not be forecasted before the telecommunication room is ready. In another example, a site cannot be complete without power. The control module 104 may autonomously search for sites where power is forecasted after the site completion and highlights the discrepancy. If necessary, the control module 104 makes adjustments to the custom lead times or task dependencies to optimize project schedules.

In an example embodiment, one or more of the following calculation methods may be used to predict activity durations: manual data entry (user provided), automatically calculated values (average, mean, max, etc.), or a program evaluation review technique which estimates project duration through a weighted average of optimistic, pessimistic, and most likely activity durations when there is uncertainty with the individual activity estimates.

In an example embodiment, the system may detect a change in a milestone, wherein based on the change, one or more dependent milestones are automatically re-forecasted in response to the changing of the milestone. Thus, a change in any milestone creates a cascade effect implemented by the project scheduling system 100 and a change in a milestone forecast affects all the proceeding milestones. For example, a project manager may change the lead time configuration for the milestone of the project in the Excel sheet and when the cascade feature is actuated, then, in turn, the project scheduling system 100 updates the lead time configuration of one or more dependent milestones, which means one or more dependent milestones are automatically re-forecasted. The project scheduling system 100 thus provides the ability to quickly cascade any milestone and re-forecast future activities based on custom lead times defined by the user to answer, for example, the following: When is site X to complete? When is the tower for site X going to complete? When can we request the material for site X? When will we reach a specific milestone for site X? How many sites will we finish by December? How many building permits will we get by next month?

The project scheduling system may also send notifications to the user by using network connections, which are related to changes in one or more project schedules, wherein the notification includes information related to project overdue. The notification related information includes notification regarding certain events that have occurred or are occurring in the project such as task completion, schedule changes, or deadline updates. The system is able to send automated notifications based on predefined rules, such as reminders for upcoming deadlines or alerts for delayed task.

Further, a user may edit project data through the project scheduling system 100. For example, the project scheduling system 100 may use MS Excel and its functionality such as formulas and macros, to create an upload file required to update forecast dates in the TPMSS 101. In an embodiment, the data can be uploaded by quick mass upload or general details mass upload, as per various user selectable options and requirements.

In an example embodiment, the following steps are followed to create an upload file for the TPMSS 101 using the project scheduling system 100. The project scheduling system 100 imports data from the associated TPMSS 101 and prepares an Excel sheet of the same in a ‘data export tab.’ If the user wants to upload general details, a general details column is selected and changes are made therein. The changes are highlighted in the upload file to be uploaded into the associated TPMSS 101. Upon clicking an upload column options, an uploaded file based on content visible in the Excel sheet is created and saved. In the associated TPMSS 101, upon clicking a general details mass upload option, the file is uploaded to associated TPMSS 101. Through this implementation of the project scheduling system 100, the project scheduling system 100 helps to answer questions such as: How many sites are forecasted to be leased in the next 3 weeks? How many sites are forecasted to start construction next week? How many sites will be on-air by the end of December?

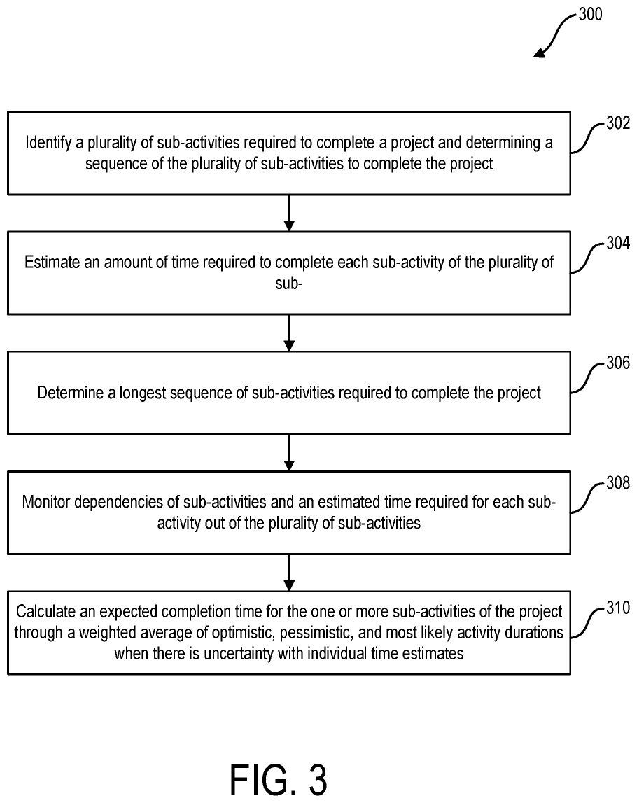

FIG. 3 illustrates a method flow diagram of method 300 for monitoring activities in a scheduled project, in accordance with an embodiment of the present disclosure. In the following, the project scheduling system 100 may schedule project activities and milestones on a site-to-site or group of sites basis.

At step 302, the control module 104 of the project scheduling system 100 identifies a plurality of sub-activities required to complete a project and determines a sequence of the plurality of sub-activities to complete the project.

At step 304, the control module 104 estimates an amount of time required to complete each sub-activity of the plurality of sub-activities.

At step 306, the control module 104 determines a longest sequence of sub-activities required to complete the project.

At step 308, the control module 104 monitors dependencies between the plurality of sub-activities and any changes in an estimated time required for each sub-activity of the plurality of sub-activities.

At step 310, the control module 104 calculates an estimated expected completion time for one or more sub-activities of the project through a weighted average of optimistic, pessimistic, and most likely activity durations, for example, when there is uncertainty with individual time estimates. In an example, the calculation may be done using the following formula: (Beta=(Pessimistic+(4*Most Likely)+Optimistic)/6). In another implementation, the control module 104 uses an estimation technique to calculate the milestone forecast using a series of automated calculations and statistical analysis.

In an embodiment, the control module is also configured to analyze project data and provides recommendations for optimizing one or more project schedules.

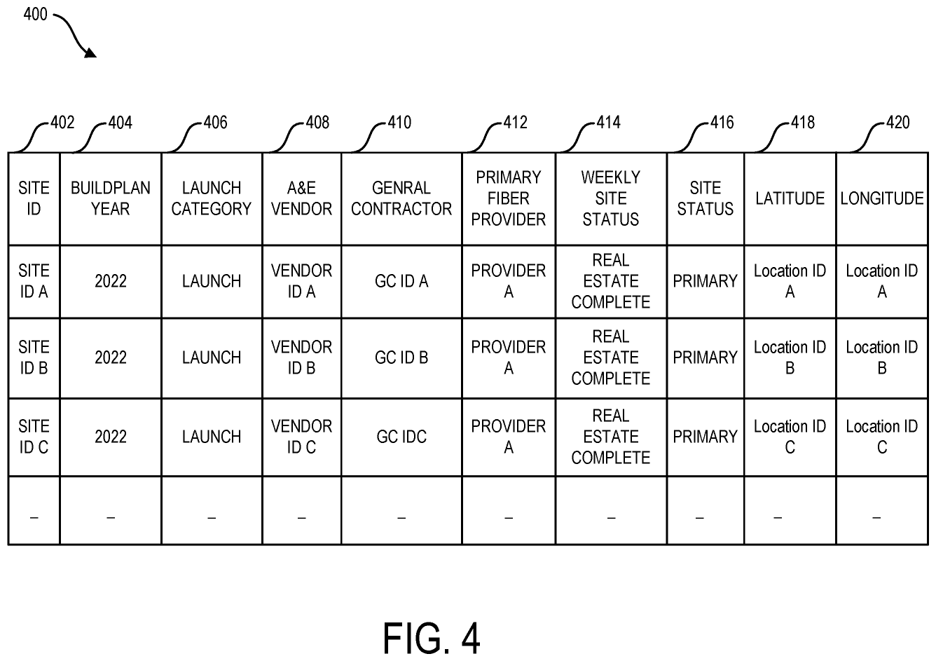

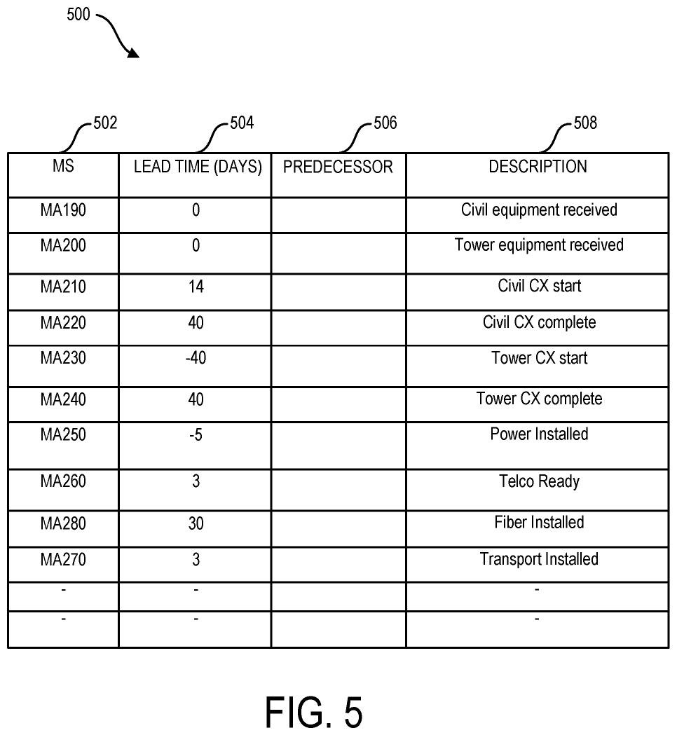

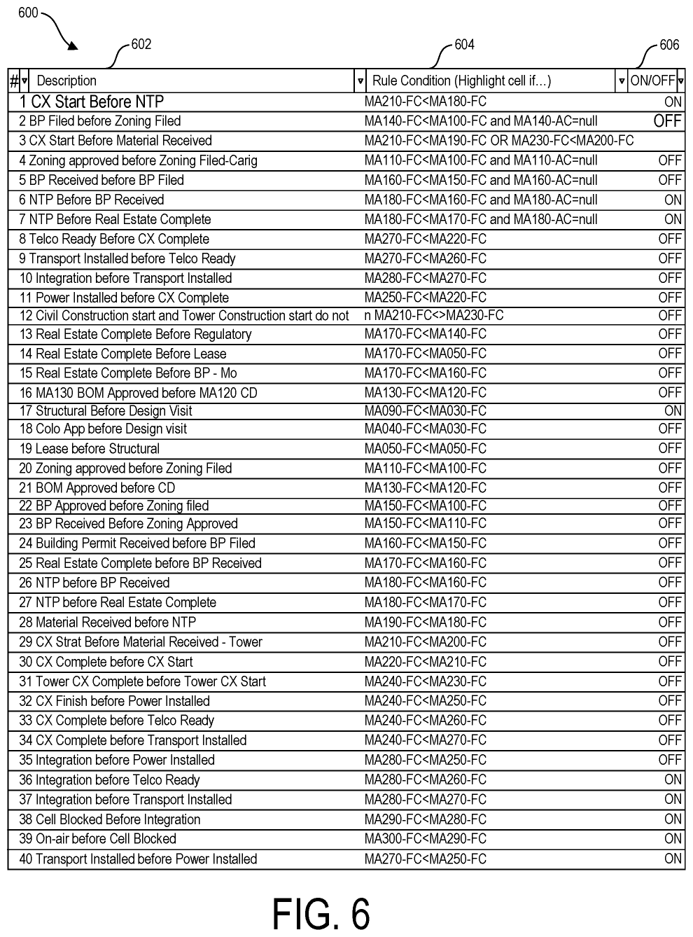

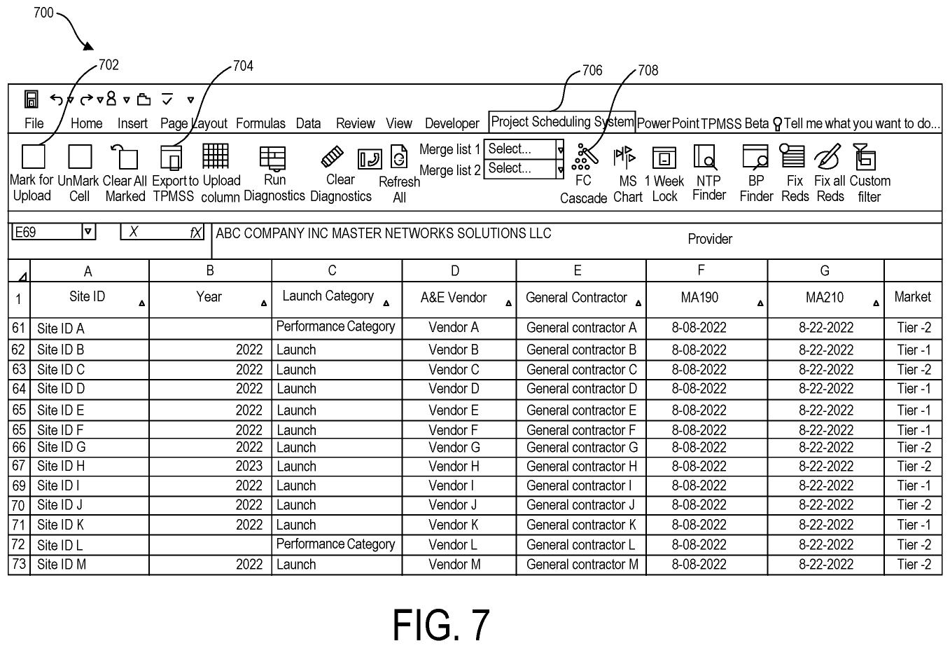

FIGS. 4-7 illustrate various user interface views showing implementation of the project scheduling system 100, including respectively a first data export view user interface 400 in FIG. 4, an interactive and modifiable lead time table 500 in FIG. 5, an interactive and modifiable diagnostic rules table 600 in FIG. 6 and a second data export view user interface 700 in FIG. 7.

FIG. 4 illustrates an exemplary first data export view user interface 400 of the project scheduling system 100, wherein specific types of information related to project data are included in one or more columns representing various project related data, for example: site ID 402 (site ID A, site ID B, site ID C . . . ), build plan year 404, launch category 406, A&E vendor 408 (Vendor ID A, Vendor ID B, Vendor ID C . . . ), general contractor 410 (General contractor ID A, General contractor ID B, General contractor ID C . . . ), primary fiber provider 412, weekly site status 414, site status 416, longitude and latitude coordinates 418 and 420, respectively). The first data export view user interface 400 includes project data information imported from the associated TPMSS 101 and downloaded in MS Excel format, according to one embodiment. Specific milestones may also be included and identified as column headers and associated milestone completion dates may also be included within those columns, such as, for example, as shown in the columns for milestones MA190 and MA210 (also referred herein to as projects, tasks, activities, project activities, or sub-activities) in the second data export view user interface 700 of FIG. 7.

FIG. 5 illustrates a representation of an interactive user interface including an interactive and modifiable lead time table 500 of the project scheduling system 100. The lead time table 500 includes one or more project activities and their corresponding individual lead times (i.e., the duration in days each project activity will take to complete in isolation). As shown, the table 500 includes various information including project activities 502, corresponding lead times 504 (in days), any predecessor activities 506, and descriptions of activities 508 for each project activity or sub-activity (also referred to as milestones herein).

The total lead time from start of the overall larger project until completion of a specific project activity is the sum of the individual lead times for the project activities appearing in the table 500 above the specific project activity plus the lead time for the specific project activity itself. For example, the total lead time from start of the overall project until completion of project activity MA220 is 0+0+14+40, which is a total of 54 days. The system enables the user to change such lead times directly within the table 500 and the system will automatically cascade one or more milestone dates and reflect these changes within the second data export view user interface 700 shown in FIG. 7, based on the changes. A negative number in the lead times 504 indicates the number of days the project activity will be complete before the project activity appearing above it in the table 500.

The sequence of the project activities 502 may also be modified within the table 500 and project activities may also be added or removed. In one example, lead time(s) for one or more activities may be configured in table 500 and the cascade of the milestone dates will be adjusted automatically in the following manner.

From the example portion below of table 500, a lead time of the power installation project activity (MA210) is shown as 14 days, which means that the Civil CX activity is to be completed 14 days after the tower equipment is received.

| MS | Lead time (Days) | Predecessor | Description |
|---|---|---|---|
| MA190 | 0 | | Civil equipment |
| | | | received |
| MA200 | 0 | | Tower equipment |
| | | | received |
| MA210 | 14 | | Civil CX start |

After configuring the lead times of activities in the table 500, according to one example embodiment, a cascade of one or more milestones may be calculated, in according with one example embodiment, based on the current lead times configuration in the following manner with reference to FIG. 7.

FIG. 7 represents an exemplary illustration of an aspect of the project scheduling system 100 showing a second data export view user interface 700 in MS Excel format for editing, handling, and processing by the project scheduling system 100, in accordance with the method as described in the foregoing description. In an example embodiment, this second data export view user interface 700 may be displayed by the user selecting the “Project Scheduling System” selectable user interface element 702. In an example embodiment, the user may switch between the table 500 and second data export view user interface 700 by selecting different tabs within a spreadsheet program, such as MS Excel or other user interface element.

In an example embodiment, the user may change one or more milestone dates in the second data export view user interface 700 shown in FIG. 7. In particular, the user may select one or more milestones for which the user wants to change the date. For example, the user may update the MA190 (Civil equipment received) date for one of the project sites (e.g., site ID B) from Aug. 8, 2022 to Aug. 15, 2022. The user may also mark such changed cells for upload to the TPMSS 101 via the “Mark for Upload” selectable user interface element 702. The user may then select the “FC Cascade” selectable user interface element 708 to initiate the cascade of affected milestones for site ID B overall larger project. This will result in the MA210 (Civil CX start) milestone date to be automatically changed to Aug. 29, 2022, which is 14 days after the updated MA190 (Civil equipment received) date according to the lead times configuration in table 500 of FIG. 5. This provides an output as the calculation of a single cascade and changes are made simultaneously in the second data export view user interface 700 based on the configuration of the lead times. In an example embodiment, the dates that are changed resulting from the cascade may be highlighted or otherwise marked automatically in the second data export view user interface 700 by the project scheduling system 100.

In another example, the user may change milestone dates for particular milestones for all the sites or for selected sites. When selecting multiple sites, corresponding changes to the affected milestone dates for each site may be performed simultaneously and be automatically reflected in the second data export view user interface 700. Also, in an example embodiment, the changes made to one lead time for a project activity, for example, for MA190, in the table 500, may be automatically reflected in the second data export view user interface 700 in the affected milestone dates of all sites simultaneously. After such forecasting, the data may be uploaded back to the associated TPMSS 101 by the user selecting the “Export to TPMSS” icon 704 and may also be reflected in a progress report in the first data export view user interface 400 of FIG. 4.

FIG. 6 illustrates a number of diagnostic rules in an interactive and modifiable diagnostic rules table 600 that may be stored, modified and applied by the project scheduling system 100 to automatically analyze and find one or more dependency related issues in project data. For example, information identifying the rule and/or related to the rule description 602, rule conditions 604 and a selection option for turning the rule on or off 606 may be stored, provided, and displayed. Based on the dependencies defined by the rules in table 600 and whether particular rules are to be applied based on them being selected to be on or off in table 600, the project scheduling system 100 may identify and notify the user of dependency issues that need to be addressed.

For example, a rule description “CX starts before NTP (Notice to Permit)” corresponds to rule condition MA210_FC<MA180_FC which applies to project activities MA210_FC and MA180_FC. This rule may be applied to these project activities, while the on or off selection is showing an ON state. The rule being in the ON sate means that this diagnostic rule is being applied to the corresponding MA210_FC and MA180_FC project activities. Otherwise, the selection may be for it to be in the OFF state.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A computer-implemented method for scheduling projects, the method comprising:
electronically receiving project data for a plurality of projects from an associated project management system;
electronically assigning, by a control module, a preliminary lead time to each project of the plurality of projects and storing the same;
electronically generating, by the control module, a look-up table for the plurality of projects;
electronically identifying, by the control module, one or more dependencies between one or more projects of the plurality of projects based on one or more dependency rules;
electronically modifying, by the control module, a preliminary lead time for one or more projects in the look-up table in response to user input;
electronically modifying, by the control module, a preliminary start date for one or more projects in the look-up table in response to user input;
electronically updating, by the control module, a corresponding schedule of the one or more projects based on the modified preliminary lead time, the modified preliminary start date and the identified one or more dependencies;
electronically displaying data indicative of the updated corresponding schedule in response to the updating of the corresponding schedule; and
electronically transmitting to the associated project management system data indicative of the updated corresponding schedule.

2. The method of claim 1, further comprising identifying a plurality of sub-activities required to complete a project and determining a sequence of the plurality of sub-activities to complete the project.

3. The method of claim 2, further comprising estimating an amount of time required to complete each sub-activity of the plurality of sub-activities.

4. The method of claim 3, further comprising determining a longest sequence of sub-activities required to complete the project.

5. The method of claim 4, further comprising monitoring dependencies between the plurality of sub-activities and any changes in an estimated time required for each sub-activity of the plurality of sub-activities.

6. The method of claim 5, further comprising calculating an expected completion time for one or more sub-activities of the project through a weighted average of optimistic, pessimistic, and most likely activity durations when there is uncertainty with individual time estimates.

7. The method of claim 1, wherein the plurality of projects comprise sub-activities of one of a plurality of larger projects, and further comprising:
applying a custom filter to the plurality of larger projects to list projects of the plurality of larger projects that meet certain selection criteria, based on the updated corresponding schedule, for completion of sub-activities within each larger project of the plurality of larger projects.

8. The method of claim 1, further comprising, analyzing the received project data for the plurality of projects and providing recommendations for optimizing the updated corresponding schedule.

9. The method of claim 1, wherein the electronically updating the corresponding schedule includes electronically updating a corresponding schedule of a plurality of projects simultaneously based on the modified preliminary lead time, the modified preliminary start date and the identified one or more dependencies.

10. A computer-implemented project scheduling system comprising:
at least one memory that stores computer executable instructions; and
at least one processor that executes the computer executable instructions to cause actions to be performed, the actions including:
electronically receiving project data for a plurality of projects from an associated project management system;
electronically assigning a preliminary lead time to each project of the plurality of projects and storing the same;
electronically generating a look-up table for the plurality of projects;
electronically identifying one or more dependencies between one or more projects of the plurality of projects based on one or more dependency rules;
electronically modifying a preliminary lead time for one or more projects in the look-up table in response to user input;
electronically modifying a preliminary start date for one or more projects in the look-up table in response to user input;
electronically updating a corresponding schedule of the one or more projects based on the modified preliminary lead time, the modified preliminary start date and the identified one or more dependencies;
electronically displaying data indicative of the updated corresponding schedule in response to the updating of the corresponding schedule; and
electronically transmitting to the associated project management system data indicative of the updated corresponding schedule.

11. The computer-implemented project scheduling system of claim 10, further comprising identifying a plurality of sub-activities required to complete a project and determining a sequence of the plurality of sub-activities to complete the project.

12. The computer-implemented project scheduling system of claim 11, further comprising estimating an amount of time required to complete each sub-activity of the plurality of sub-activities.

13. The computer-implemented project scheduling system of claim 12, further comprising determining a longest sequence of sub-activities required to complete the project.

14. The computer-implemented project scheduling system of claim 13, further comprising monitoring dependencies between the plurality of sub-activities and any changes in an estimated time required for each sub-activity of the plurality of sub-activities.

15. The computer-implemented project scheduling system of claim 14, further comprising calculating an expected completion time for one or more sub-activities of the project through a weighted average of optimistic, pessimistic, and most likely activity durations when there is uncertainty with individual time estimates.

16. A non-transitory computer-readable storage medium having computer executable instructions stored therein that, when executed by at least one computer processor, cause actions to be performed, the actions including:
electronically receiving project data for a plurality of projects from an associated project management system;
electronically assigning a preliminary lead time to each project of the plurality of projects and storing the same;
electronically generating a look-up table for the plurality of projects;
electronically identifying one or more dependencies between one or more projects of the plurality of projects based on one or more dependency rules;
electronically modifying a preliminary lead time for one or more projects in the look-up table in response to user input;
electronically modifying a preliminary start date for one or more projects in the look-up table in response to user input;
electronically updating a corresponding schedule of the one or more projects based on the modified preliminary lead time, the modified preliminary start date and the identified one or more dependencies;
electronically displaying data indicative of the updated corresponding schedule in response to the updating of the corresponding schedule; and
electronically transmitting to the associated project management system data indicative of the updated corresponding schedule.

17. The non-transitory computer-readable storage medium of claim 16, further comprising identifying a plurality of sub-activities required to complete a project and determining a sequence of the plurality of sub-activities to complete the project.

18. The non-transitory computer-readable storage medium of claim 17, further comprising estimating an amount of time required to complete each sub-activity of the plurality of sub-activities.

19. The non-transitory computer-readable storage medium of claim 18, further comprising determining a longest sequence of sub-activities required to complete the project.

20. The non-transitory computer-readable storage medium of claim 19, further comprising monitoring dependencies between the plurality of sub-activities and any changes in an estimated time required for each sub-activity of the plurality of sub-activities.
